(19) United States
(12) Patent Application Publication
(10) Pub. No.: US 2007/0282982 A1
(43) Pub. Date: Dec. 6, 2007

(54) Policy-Based Management in a Computer Environment

(76) Inventors: Rhonda Childress, Austin, TX (US); Oded Dubovsky, Haifa (IL); Itzhack Goldberg, Hadera (IL); Ido Levy, Kiryat Mozkin (IL); Ziv Rafalovich, Yokneam (IL); Ramakrishnan Rajamony, Austin, TX (US); Eric Van Hensbergen, Austin, TX (US); Martin Tross, Haifa (IL)

Correspondence Address: Stephen C. Kaufman;IBM CORPORATION, Intellectual Property Law Dept., P.O. Box 218, Yorktown Heights, NY, 10598, US

(21) Appl. No.: 11/422,127

(22) Filed: Jun. 5, 2006

(51) Int. Cl. G06F 15/173

(52) U.S. Cl. 709/223

(57) ABSTRACT

A system for policy-based management in a computer environment, the system including at least one rule configured to be applied to an element of a computer environment, at least one policy including at least one of the rules, at least one profile including at least one element of the computer environment, at least one association defining a relationship between one of the policies and one of the profiles, and a computer configured to instaniate any of the associations, thereby invoking any of the rules included in the related policy for application to any of the elements in the related profile.

### FIELD OF THE INVENTION

The present invention relates in general to policy-based management in a computer environment.

### BACKGROUND OF THE INVENTION

While the use of policy-based management systems in computer environments has made managing complex computing environments more efficient, such systems often suffer from any of several drawbacks. For example, it is difficult to customize a policy for a large number of computer systems, to apply customized policies to a group of servers, and to implement policy exceptions in large-scale computer environments.

A mechanism for policy-based management in a computer environment that allows for greater configuration flexibility would therefore be advantageous.

### SUMMARY OF THE INVENTION

The present invention discloses a system and method for policy-based management in a computer environment.

In one aspect of the present invention a system is provided for policy-based management in a computer environment, the system including at least one rule configured to be applied to an element of a computer environment, at least one policy including at least one of the rules, at least one profile including at least one element of the computer environment, at least one association defining a relationship between one of the policies and one of the profiles, and a computer configured to instantiate any of the associations, thereby invoking any of the rules included in the related policy for application to any of the elements in the related profile.

In another aspect of the present invention any of the rules are associated with a set of computer-executable instructions.

In another aspect of the present invention any of the rules may include at least one parameter, the value of which is operative to affect how the instructions are applied.

In another aspect of the present invention any of the rules are associated with a set of configuration/setting parameters.

In another aspect of the present invention any of the rules, policies, associations, and profiles may have at least one associated value, and further includes a precedence hierarchy for determining which of the values in any of the rules, policies, associations, and profiles override corresponding values in any other of the rules, policies, associations, and profiles.

In another aspect of the present invention a system is provided for policy-based management in a computer environment, the system including at least one rule configured to be applied to an element of a computer environment, at least one profile including at least one element of the computer environment, at least one association defining a relationship between one of the rules and one of the profiles, and a computer configured to instantiate any of the associations, thereby applying the rule to any of the elements in the related profile.

In another aspect of the present invention any of the rules are associated with a set of computer-executable instructions.

In another aspect of the present invention any of the rules may include at least one parameter, the value of which is operative to affect how the instructions are applied.

In another aspect of the present invention any of the rules are associated with a set of configuration/setting parameters.

In another aspect of the present invention any of the rules, associations, and profiles may have at least one associated value, and further includes a precedence hierarchy for determining which of the values in any of the rules, associations, and profiles override corresponding values in any other of the rules, associations, and profiles.

In another aspect of the present invention a method is provided for policy-based management in a computer environment, the method including defining at least one rule configured to be applied to an element of a computer environment, defining at least one policy including at least one of the rules, defining at least one profile including at least one element of the computer environment, defining at least one association defining a relationship between one of the policies and one of the profiles, and configuring a computer to instantiate any of the associations, thereby invoking any of the rules included in the related policy for application to any of the elements in the related profile.

In another aspect of the present invention the rule defining step includes defining any of the rules to be associated with a set of computer-executable instructions.

In another aspect of the present invention the rule defining step includes defining any of the rules to include at least one parameter, the value of which is operative to affect how the instructions are applied.

In another aspect of the present invention the rule defining step includes defining any of the rules to be associated with a set of configuration/setting parameters.

In another aspect of the present invention defining steps includes defining any of the rules, policies, associations, and profiles to have at least one associated value, and further includes defining a precedence hierarchy for determining which of the values in any of the rules, policies, associations, and profiles override corresponding values in any other of the rules, policies, associations, and profiles.

In another aspect of the present invention a method is provided for policy-based management in a computer environment, the method including defining at least one rule configured to be applied to an element of a computer environment, defining at least one profile including at least one element of the computer environment, defining at least one association defining a relationship between one of the rules and one of the profiles, and configuring a computer to instantiate any of the associations, thereby applying the rule to any of the elements in the related profile.

In another aspect of the present invention the rule defining step includes defining any of the rules to be associated with a set of computer-executable instructions.

In another aspect of the present invention the rule defining step includes defining any of the rules to include at least one parameter, the value of which is operative to affect how the instructions are applied.

In another aspect of the present invention the rule defining step includes defining any of the rules to be associated with a set of configuration/setting parameters.

In another aspect of the present invention defining steps includes defining any of the rules, associations, and profiles to have at least one associated value, and further includes defining a precedence hierarchy for determining which of the values in any of the rules, associations, and profiles override corresponding values in any other of the rules, associations, and profiles.

### BRIEF DESCRIPTION OF THE DRAWINGS

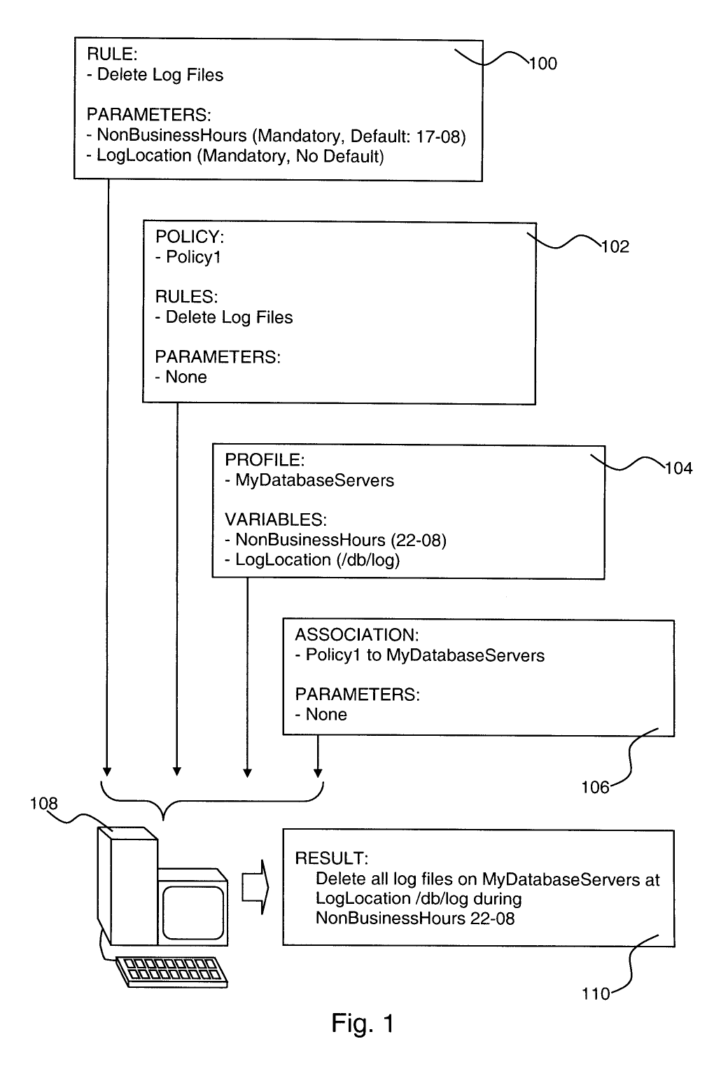

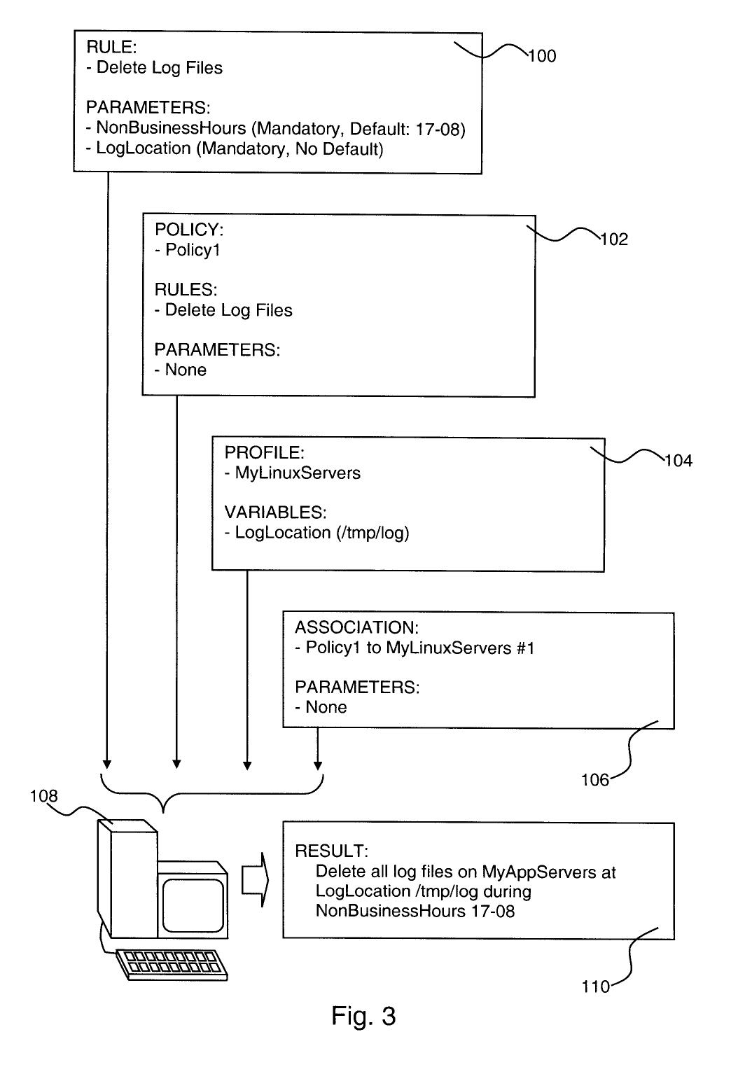

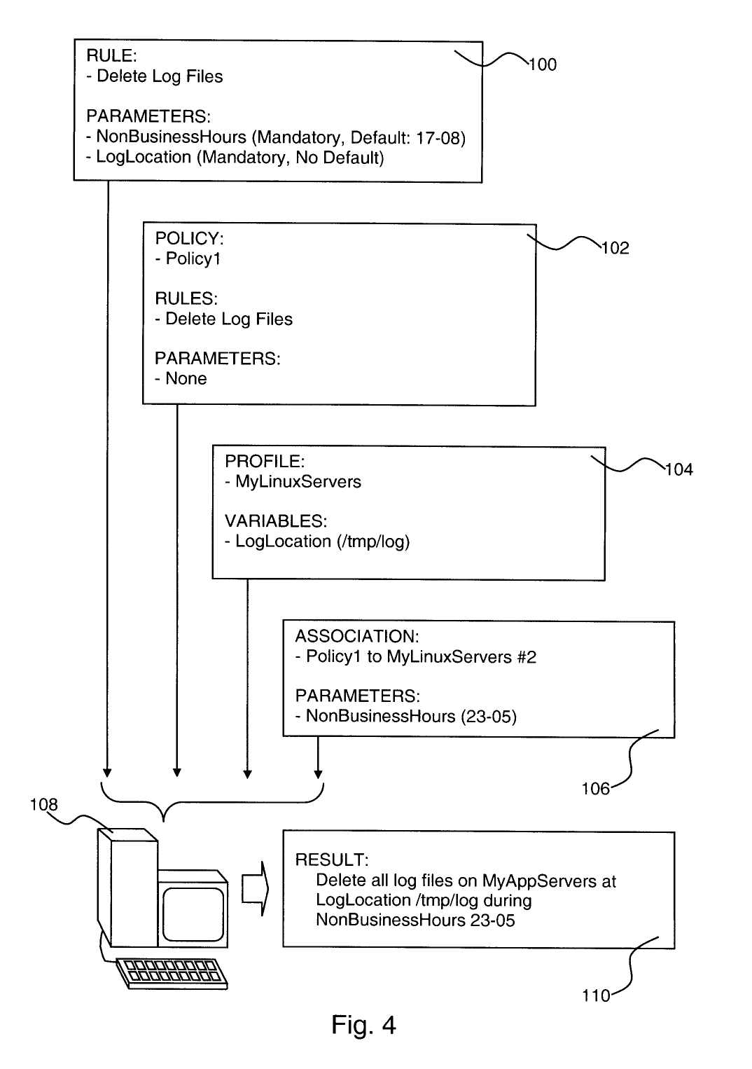

The present invention will be understood and appreciated more fully from the following detailed description taken in conjunction with the appended drawings in which FIGS. 1-5 are simplified conceptual flow illustrations of exemplary implementation scenarios of a system for policy-based management in a computer environment, constructed and operative in accordance with a preferred embodiment of the present invention.

### DETAILED DESCRIPTION OF THE INVENTION

Reference is now made to FIG. 1, which is a simplified conceptual flow illustration of a system for policy-based management in a computer environment, constructed and operative in accordance with a preferred embodiment of the present invention. In the system of FIG. 1, one or more rules 100 are defined, where each rule 100 is a declaration which can be applied to physical or logical elements of a computer environment, such as computers, databases, communications ports, etc. Each rule 100 may be associated with a set of configuration/setting parameters, such as may be used to customize software/hardware components, and/or a set of computer-executable instructions that may include one or more parameters, the values of which may affect how the instructions are applied. For example, in FIG. 1 rule 100 relates to deleting log files, and includes the parameter “NonBusinessHours” which indicates the time during which the rule may be applied, as well as the parameter “LogLocation” which indicates the location of log files to be deleted. Each parameter may have a type, a default value, and may be mandatory or optional, where a rule cannot be applied if the parameter does not receive a value during processing. The value for a rule parameter may come from any source, such as an input file, an environment variable, or a name/value mapping (e.g., hostname=haifa.ibm.com). One or more policies 102 are defined, where each policy 102 may include one or more rules 100, where the same rule may be included in more than one policy. One or more profiles 104 are defined, where each profile 104 includes one or more physical or logical elements of a computer environment, such as computers, databases, communications ports, etc., which may be identified by unique identifiers such as server host-names, IP addresses, etc., or by attributes, such as the existence of a specific file, installed software package, or a running process. For example, the existence of a specific file or directory may indicate the existence of a particular entity, such as where the existence of the directory /home/jones or the existence of a line containing “jones” in the file /etc/passwd may indicate that the entity Jones exists and has an account on the computer, and by extension all computers which have a directory named /home/jones are computers on which Jones has an account. Such identifying information may be maintained in a database or evaluated during the application of the policy-based system of the present invention. The same computer environment element, such as a particular server, may be included in more than one profile. One or more associations 106 are defined, where each association 106 defines a relationship between a policy 102 and a profile 104, where the same policy may be included in different associations with different profiles, and where the same profile may be included in different associations with different policies. The instantiation of an association 106 invokes the rules 100 of a policy 102 for application to the elements of a profile 104, such as may be implemented by a computer 108.

Any of the parameter values of any rule 100 may be overridden through the application of corresponding parameter values or variable values that are associated with any policy 102, profile 104, and/or association 106. For example, each policy 102 may include one or more parameters, where a policy parameter value may be used to override corresponding parameter values of any rules 100 included in policy 102. The value for a policy parameter may come from any source, such as an external management system which maps business content or any other content to computing resources (e.g., security constraints that are mapped to profile variables and used by security rules and policies). Similarly, each profile 104 may include one or more variables, where a profile variable may be used to override corresponding parameter values of any rules 100 or policies 102. Likewise, association 106 may include one or more parameters, where an association parameter value may be used to override corresponding parameter values of any rules 100, policies 102, or profiles 104.

Thus, in the example shown in FIG. 1, the instantiation of association 106 results in the application of the policy “Policy1” to the profile “MyDatabaseServers.” The value “22-08” of the variable “NonBusinessHours” of the “MyDatabaseServers” profile overrides the corresponding “NonBusinessHours” parameter of the “Delete Log Files” rule that is part of Policy1, as does the value “/db/log” of the variable “LogLocation” in profile 104 override the corresponding “LogLocation” parameter of the “Delete Log Files” rule 100. The result 110 of the application of “Policy1” to “MyDatabaseServers” results in the deletion of all log files on any elements belonging to the “MyDatabaseServers” profile at the location /db/log. The deletion will take place during the non business hours between 22:00 and 08:00.

It will be appreciated that various precedence hierarchies may be constructed for determining which parameter or variable values in rules, policies, profiles, and associations override which other corresponding values in other rules, policies, profiles, and associations.

The present invention may be additionally understood in the context of the following scenarios given the following rule, policy, profile, and association definitions:

```
Profile
    “MyDatabaseServers” includes my database servers
Variables:
    NonBusinessHours: 22-08
    LogLocation: /db/log
EndProfile
  Profile:
    “MyLinuxServers” includes my linux servers
Variables:
    LogLocation: /tmp/log
EndProfile
  Profile:
    “MyAppServers” includes my application servers
Variables:
    NonBusinessHours: 17-09
EndProfile
Rule:
    Delete log files
Parameters:
    NonBusinessHours: Default value: 17-08
    LogLocation: Mandatory, no default value
EndRule
Policy:
    Policy1
Rules:
    Delete log files
EndPolicy
Policy:
    Policy2 - delete application log files
Rules:
    Delete log files
Parameters:
    LogLocation: /app/log
EndPolicy
Association:
    Policy1/MyDatabaseServers
EndAssociation
Association:
    Policy2/MyAppServers
EndAssociation
Association:
    Policy1/MyLinuxServers #1
EndAssociation
Association:
    Policy1/MyLinuxServers #2
Parameters:
    NonBusinessHours: 23-05
EndAssociation
Scenario 1: Use parameters from the profile only
Instantiate Association:
    Policy1/MyDatabaseServers
Result:
    NonBusinessHours: 22-08 (from the MyDatabaseServers profile)
    LogLocation: /db/log (from the MyDatabaseServers profile)
EndScenario
Scenario 2: Use parameters from the profile and policy
Instantiate Association:
    Policy2/MyAppServers
Result :
    NonBusinessHours: 17-09 (from the MyAppServers profile)
    LogLocation: /app/log (from the Policy2 policy)
EndScenario
Scenario 3: Use parameters from the rule (default) and profile
Instantiate Association:
    Policy1/MyLinuxServers #1
    Result :
      NonBusinessHours: 17-08 (from the Delete log files rule - default)
      LogLocation: /tmp/log (from the MyLinuxServers profile)
    EndScenario
    Scenario 4: Use parameters from the association and profile
    Instantiate Association:
      Policy1/MyLinuxServers #2
    Result :
      NonBusinessHours: 23-05 (from the Policy1/MyLinuxServers #2
association)
      LogLocation: /tmp/log (from the MyLinuxServers profile)
    EndScenario
```

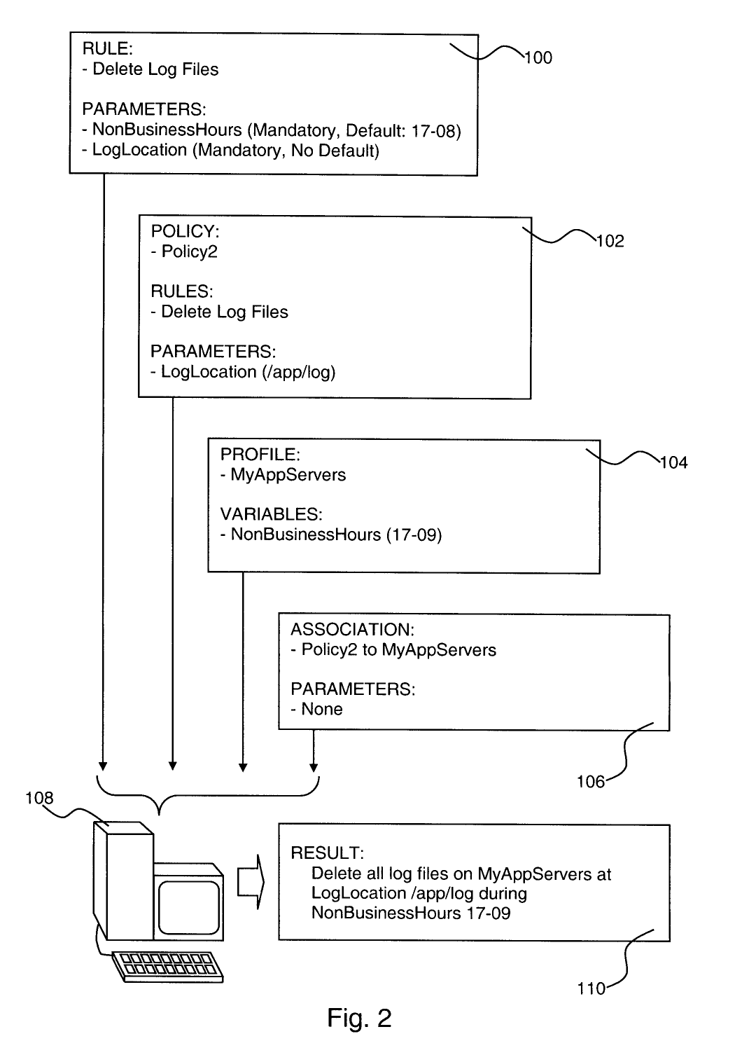

Scenario #1 is shown in FIG. 1, with scenarios #2, #3, and #4 being shown in FIGS. 2, 3, and 4 respectively.

If a rule parameter is defined as mandatory with no default value, and no value is assigned to it during the instantiation of an association, either by the association or its policy or profile, such an association may be invalidated and prevented from being applied.

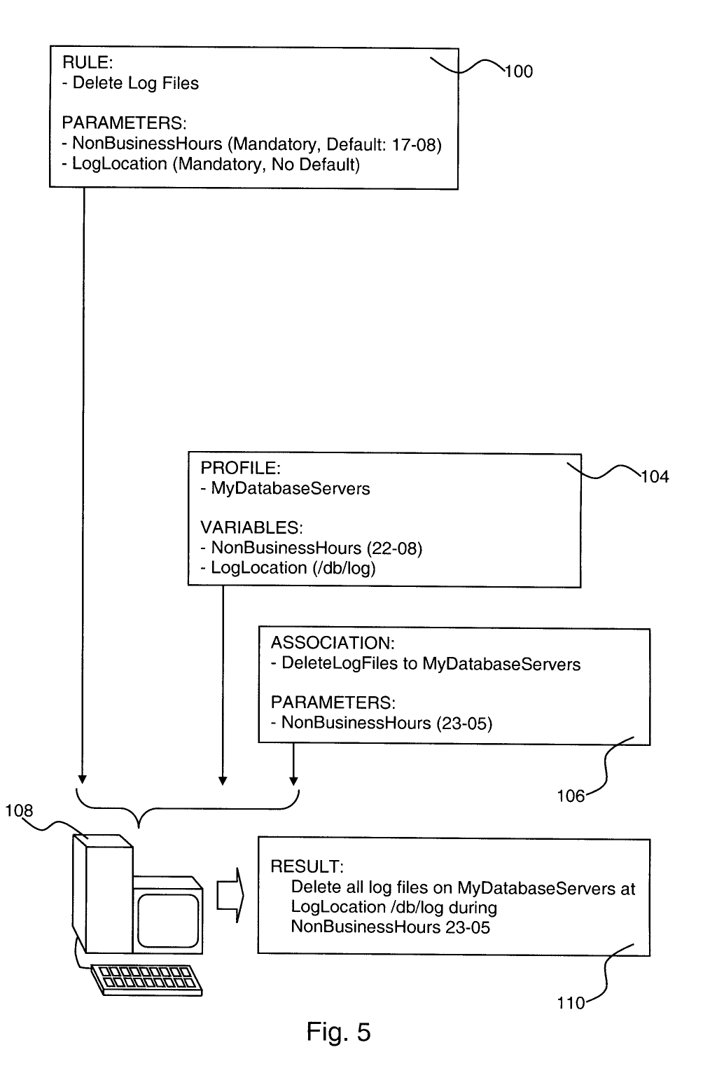

Reference is now made to FIG. 5, which is a simplified conceptual flow illustration of a system for policy-based management in a computer environment, constructed and operative in accordance with a preferred embodiment of the present invention. The system of FIG. 5 is substantially similar to the system shown in FIGS. 1-4 with the notable exception that associations 106 may be defined directly between rules 100 and profiles 104. For example, given the rule and profile definitions above, the following association may be defined:

```
Association:
    DeleteLogFiles/MyDatabaseServers #1
EndAssociation
Association:
    DeleteLogFiles/MyDatabaseServers #2
Parameters:
    NonBusinessHours: 23-05
EndAssociation
```

The instantiation of DeleteLogFiles/MyDatabaseServers #2 would then result in the following scenario:

```
Scenario 5:
Instantiate Association:
    DeleteLogFiles/MyDatabaseServers #2
Result:
    NonBusinessHours: 23-05 (from the
        DeleteLogFiles/MyDatabaseServers #2 association)
    LogLocation: /db/log (from the MyDatabaseServers profile)
EndScenario
```

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A system for policy-based management in a computer environment, the system comprising:
at least one rule configured to be applied to an element of a computer environment;
at least one policy including at least one of said rules;
at least one profile including at least one element of said computer environment;
at least one association defining a relationship between one of said policies and one of said profiles; and
a computer configured to instantiate any of said associations, thereby invoking any of said rules included in said related policy for application to any of said elements in said related profile.

2. A system according to claim 1 wherein any of said rules are associated with a set of computer-executable instructions.

3. A system according to claim 2 wherein any of said rules may include at least one parameter, the value of which is operative to affect how said instructions are applied.

4. A system according to claim 1 wherein any of said rules are associated with a set of configuration/setting parameters.

5. A system according to claim 1 and wherein any of said rules, policies, associations, and profiles may have at least one associated value, and further comprising a precedence hierarchy for determining which of said values in any of said rules, policies, associations, and profiles override corresponding values in any other of said rules, policies, associations, and profiles.

6. A system for policy-based management in a computer environment, the system comprising:
at least one rule configured to be applied to an element of a computer environment;
at least one profile including at least one element of said computer environment;
at least one association defining a relationship between one of said rules and one of said profiles; and
a computer configured to instantiate any of said associations, thereby applying said rule to any of said elements in said related profile.

7. A system according to claim 6 wherein any of said rules are associated with a set of computer-executable instructions.

8. A system according to claim 7 wherein any of said rules may include at least one parameter, the value of which is operative to affect how said instructions are applied.

9. A system according to claim 6 wherein any of said rules are associated with a set of configuration/setting parameters.

10. A system according to claim 6 and wherein any of said rules, associations, and profiles may have at least one associated value, and further comprising a precedence hierarchy for determining which of said values in any of said rules, associations, and profiles override corresponding values in any other of said rules, associations, and profiles.

11. A method for policy-based management in a computer environment, the method comprising:
defining at least one rule configured to be applied to an element of a computer environment;
defining at least one policy including at least one of said rules;
defining at least one profile including at least one element of said computer environment;
defining at least one association defining a relationship between one of said policies and one of said profiles; and
configuring a computer to instantiate any of said associations, thereby invoking any of said rules included in said related policy for application to any of said elements in said related profile.

12. A method according to claim 11 wherein said rule defining step comprises defining any of said rules to be associated with a set of computer-executable instructions.

13. A method according to claim 12 wherein said rule defining step comprises defining any of said rules to include at least one parameter, the value of which is operative to affect how said instructions are applied.

14. A method according to claim 11 wherein said rule defining step comprises defining any of said rules to be associated with a set of configuration/setting parameters.

15. A method according to claim 11 and wherein defining steps comprises defining any of said rules, policies, associations, and profiles to have at least one associated value, and further comprising defining a precedence hierarchy for determining which of said values in any of said rules, policies, associations, and profiles override corresponding values in any other of said rules, policies, associations, and profiles.

16. A method for policy-based management in a computer environment, the method comprising:
defining at least one rule configured to be applied to an element of a computer environment;
defining at least one profile including at least one element of said computer environment;
defining at least one association defining a relationship between one of said rules and one of said profiles; and
configuring a computer to instantiate any of said associations, thereby applying said rule to any of said elements in said related profile.

17. A method according to claim 16 wherein said rule defining step comprises defining any of said rules to be associated with a set of computer-executable instructions.

18. A method according to claim 17 wherein said rule defining step comprises defining any of said rules to include at least one parameter, the value of which is operative to affect how said instructions are applied.

19. A method according to claim 16 wherein said rule defining step comprises defining any of said rules to be associated with a set of configuration/setting parameters.

20. A method according to claim 16 and wherein defining steps comprises defining any of said rules, associations, and profiles to have at least one associated value, and further comprising defining a precedence hierarchy for determining which of said values in any of said rules, associations, and profiles override corresponding values in any other of said rules, associations, and profiles.
